(19) United States
(12) Patent Application Publication
(10) Pub. No.: US 2015/0162871 A1
(43) Pub. Date: Jun. 11, 2015

(54) Method of Cell Isolation in Photovoltaic Solar Module or Solar Array

(71) Applicant: Jean-Claude Koffi Rock, Chicago, IL (US)

(72) Inventor: Jean-Claude Koffi Rock, Chicago, IL (US)

(21) Appl. No.: 14/098,668

(22) Filed: Dec. 6, 2013

(51) Int. Cl. G01R 31/40

(52) U.S. Cl. CPC H02S 50/00

(57) ABSTRACT

This disclosure puts the light on the “method of cell isolation” in photovoltaic (PV) solar module and solar array. The present method and device prevent a shaded cell to affect the power of a PV solar module. The device controls every individual cell in the module or in the array. In a standard PV solar module of 60 cells for instance, if one individual cell is shaded the device isolates the shaded cell and allows the power of the 59 remaining cells to be harvested without suffering other losses. In other words, if one cell is shaded only the power of this cell is lost. Consequently, the power lost in a PV solar module or solar array is proportional to the number of cells shaded in that module or array. The device has 3 main parts: the “Command”, the “Check Cell” and the “Relay”. The Command circuit sends in the loop a pulse to the Check Cell circuits which role is to compare the voltage of the cells against a reference voltage. If a “cell k” is shaded, the “Check Cell k” commands the “Relay k” to close allowing the main current to flow through the relay. When the “Check Cell k” receives again a pulse from the Command circuit and the “cell k” is no longer shaded, then it commands the relay to open.

### BACKGROUND

The present disclosure reveals a method and device built around the “method of cell isolation” in the photovoltaic solar module or solar array.

### SUMMARY

This disclosure exposes the “method of cell isolation” in the solar module or solar array. The main objective is to prevent a shaded cell to affect the power of the module. The method allows to short-circuit the shaded cell using a power relay, open by default, that is in parallel with the cell. The shaded cell is then isolated within the module and the main current flows through the power relay. Only the cells that are not shaded compose the new module. To deliver this function, the system is designed with three parts: the “Command”, the “Check Cell”, and the “Relay”. The details of one or more embodiments of the device are set forth in the description below. Other features, objects and advantages of the device will be apparent from the appended examples and claims.

### I. The Command

The Command circuit is designed to send a pulse in the loop to each Check Cell circuit. FIG. 2 shows the Command schematic of one standard PV solar module of 60 cells. It has one Timer, two Counters, one Gate, and five Decoders. Each output sends a pulse to one Check Cell circuit. The frequency of the timer depends on the reed relay used in the Check Cell circuit. For instance, the operating time of the reed relay PRMA 2-form-A is 0.25 ms which corresponds to a frequency of 4000 Hz. With 10% margin of error, the frequency of the timer is set at 3600 Hz. With one standard PV solar module, each cell will be “checked” 60 times in one second. This frequency will change depending on the type of reed relay used. But here, the PRMA 2-form-A specifications will be kept. FIG. 3 shows the frequency graph of the pulse. The pulse lasts 0.278 ms, and for one module, it takes 16.7 ms to complete one loop. This means the device has at most 16.7 ms to react to a shading situation.

### II. The Check Cell

Each individual cell in the module is monitored by its own Check Cell circuit. FIG. 4 shows the voltage of a completely shaded cell in 48 cells solar module (only one cell is shaded at the time). The voltage or each shaded cell is negative. The Check Cell circuit (FIG. 5) is built with a Voltage Comparator where the reference voltage is connected to the ground (zero volt). When the Check Cell circuit receives a pulse from the Command circuit, the Comparator compares the voltage of the cell against the reference voltage during the pulse time. If the cell's voltage is positive, no action is required. But if the cell's voltage is negative, the Comparator sends a signal to the Flip-Flop which changes its state. The Flip-Flop keeps this value in its memory until the Check Cell circuit receives another pulse. In the next loop, if the cell's voltage changes to positive then the value of the memory is cleared and the Flip-Flop goes back to its previous state. Reed relays are used in the Check cell circuit and have three functions. As mechanical relay, they are good for noise reduction. They also prevent a conflict between the cells polarities and the ground. Finally, the operating time of the reed relay determines the maximum frequency of the Command's circuit Timer.

### III. The Relay

Each individual cell is in parallel with a power relay which is open by default. The Relay circuit receives a signal from the Flip-Flop if the cell at which it is connected to is shaded. It closes and then short-circuits the cell. In this case, the main current of the module flows through the relay preventing the shaded cell to affect the power of the module.

### IV. Power Supply

The device is powered by a symmetrical power supply, +5 V and −5 V. If 12 V power relay is chosen +12 V power supply may be used. The power consumed by the system is mostly due to the power relay. When there is no shading and the power relays are all open, the system consumes a vey low power (close to zero). FIG. 10 is the graph of the power consumed by the system versus the number of shaded cells in 48 cells solar module. For instance, the specifications of the power relay SRD-05VDC-SL-C are 5 V direct current and 0.36 W power. Using this relay in the device, the positive power supply for one standard module of 60 cells is 21.6 W. The negative power supply is required only to detect the negative voltage of the shaded cell. It does not need much power which can be kept as low as possible. For one standard module 0.1 watt is sufficient.

### V. More than One Solar Module

To extend this method to two or more PV solar modules, the “Command” circuit is the only part of the design that will be updated, and also the value of the power supply will increase as well. There will be no modification of the “Check Cell” circuit and the “Relay” circuit. However, their number will increase with the number of cells. For 2 standard modules, the Command circuit will be designed to handle 120 cells, dealing with one cell at the time. What is the maximum modules the Command circuit can be designed for? The maximum number depends on the frequency of the reed relay used in the Check Cell circuit. With the reed relay PRMA 2-form-A, the frequency of the Command's timer is set at 3600 Hz (4000 Hz with 10% margin of error). A standard PV solar module has 60 cells. Assuming that each cell is checked 2 times per second in minimum, then 30 solar modules are needed to match 3600 Hz. The Command circuit in this case will handle 1800 cells with 1800 individual Check Cell circuits and 1800 Relay circuits. All the system is powered by the same symmetrical power supply, but here the value of the power has a factor of 30. The pulse time still lasts 0.278 ms, but it will take 0.5 sec to accomplish one loop of 1800 cells. What is the effect of this design on the power of the 30 solar modules? None. This design does not take into account how the power of the modules will be used. It is up to the user, depending on the need, to determine how the modules will be connected within the array. This means any devices, apparatus, or system can be used with the solar modules' power output. In other words, the equipment used to harvest the modules' power is not affected by the design. Now, if there is a need for more than 30 modules, what should be done is to duplicate the design. For example, an installation array that needs 100 solar modules will be done with 3 Command circuits of 30 panels and 1 Command circuit of 10 panels, assuming that the reed relay PRMA 2-form-A is used with 10% margin of error. This will be followed by 4 symmetrical power supplies where each array has its own power supply. This design takes the 30 modules as if they are one entity and deals with each cell in that entity once at the time. This means an user can install an array of different type of modules with different number of cells within each module and build a Command circuit for the total number of cells in the array, and with the freedom to use the power of those modules in any combination within the array.

The improvement of this design over the current solar panels on the market is seen in how power is lost with respect to shading situation. A standard solar panel of 60 cells has 3 substrings of 20 cells each. When one cell is shaded, the power of the entire substring where the shading occurs is lost. It is like all the 20 cells in that substring have been shaded. The consequence is that in the situation where 3 cells are shaded in the module with one cell in each substring, the power of the module can be reduced to almost zero. This design prevents such lost. In this particular shading situation, with this design, the module will only lose the power of the 3 shaded cells.

### BRIEF DESCRIPTION OF THE DRAWING

With respect to the accompanying drawing, description, and appended claims, the features and advantages of the disclosure will become better understood.

FIG. 1 is a schematic that shows the system in general with its important parts. In addition to the module itself, the system is composed of three main parts: the Command, the Check Cell, and the Relay. For a standard solar module, the number N is 60. This number can be extended to a plurality of solar modules and taking into account the type of reed relay used in the Check Cell circuit. In the example of the reed relay PRMA 2-form-A, the number N is 1800 with 2 Hz as the minimum frequency of each pulse.

FIG. 2 shows the Command circuit of one standard solar module (60 cells). This schematic contains a Timer, two Counters, one Gate, and five Decoders where one decoder has low output and the four remaining have 16 high outputs each. The Command has 60 outputs which correspond to the number of cells in the module. The signal or pulse is sent in the loop from the first to the last output and repeats itself.

FIG. 3 is a graph that shows the frequency of one output of the Command circuit which has 60 outputs. The pulse last 0.278 ms. The second output sends it pulse after a delay of 0.278 ms and so on. It takes 16.7 ms to complete one loop which means it takes at most 16.7 ms for the device to react to a shading situation.

FIG. 4 is a graph that represents the voltage of a shading cell in 48 cells solar module. In this experiment, the cell is completely shaded and its voltage is negative. It is important to notice that the cell does not need to be completely shaded before its voltage starts to be negative. The device is designed to react as soon as the cell's voltage drops below zero volt.

FIG. 5 is the “Check Cell” schematic. The reference voltage is set to zero volt (connected to the ground). The “Voltage Comparator” compares the voltage of the cell against the reference voltage. Each time the cell's voltage goes below zero volt, which is the moment where the shaded cell starts to have a significant effect on the module's power, the Voltage Comparator sends a signal to the Flip-Flop which changes its state. The Flip-Flop not only takes action, but also keeps this value into its memory and waits until the Check Cell receives another pulse in the next loop from the Command. Depending on the state of the cell, the memory will be cleared if the cell is no longer shaded or it will be left as it is if the cell is still shaded.

FIG. 6 shows a power relay that is commanded by the Flip-Flop. The relay short-circuits the cell when it receives a positive signal from the Flip-Flop. Otherwise, it stays open. In the design, all the power relays are open by default.

FIG. 7 is the schematic of the Command circuit of 30 standard solar modules. This Command circuit has 1800 outputs which correspond to 1800 cells in the array. Compared to the Command circuit of one standard solar module (FIG. 2) this circuit has more components, 121 Decoders following by OR Gates with 120 inputs.

FIG. 8 shows the frequency graph of the output of the Command circuit of 30 modules. The pulse still lasts 0.278 ms. But here, it takes 0.5 second to complete one loop which means it will take at most 0.5 second for the device to react to a shading situation. Each cell is checked 2 times in one second compared to 60 times per second for one module. Consequently, it takes more time for the device to react to a shading situation if it has to deal with more modules.

FIG. 9 shows an array of 30 solar modules and its Command circuit. Each connection between an output of the Command and a module is a 60 electrical wires connection which means one output in the schematic is a group of 60 outputs. A very interesting thing here is that the modules positive and negative electrical power outputs are left unused. Any devices and apparatus can be used to harvest the power of the array, and the modules can be connected into any combination.

FIG. 10 is the graph of the power consumed by the system versus the number of shaded cells in 48 cells solar module. The graph is almost linear which means the power adds as the number of cells shaded increases. The power consumed is close to zero when no cell is shaded which is a good thing for the device. This means almost no power is wasted when there is no shading situation.

### DETAILED DESCRIPTION

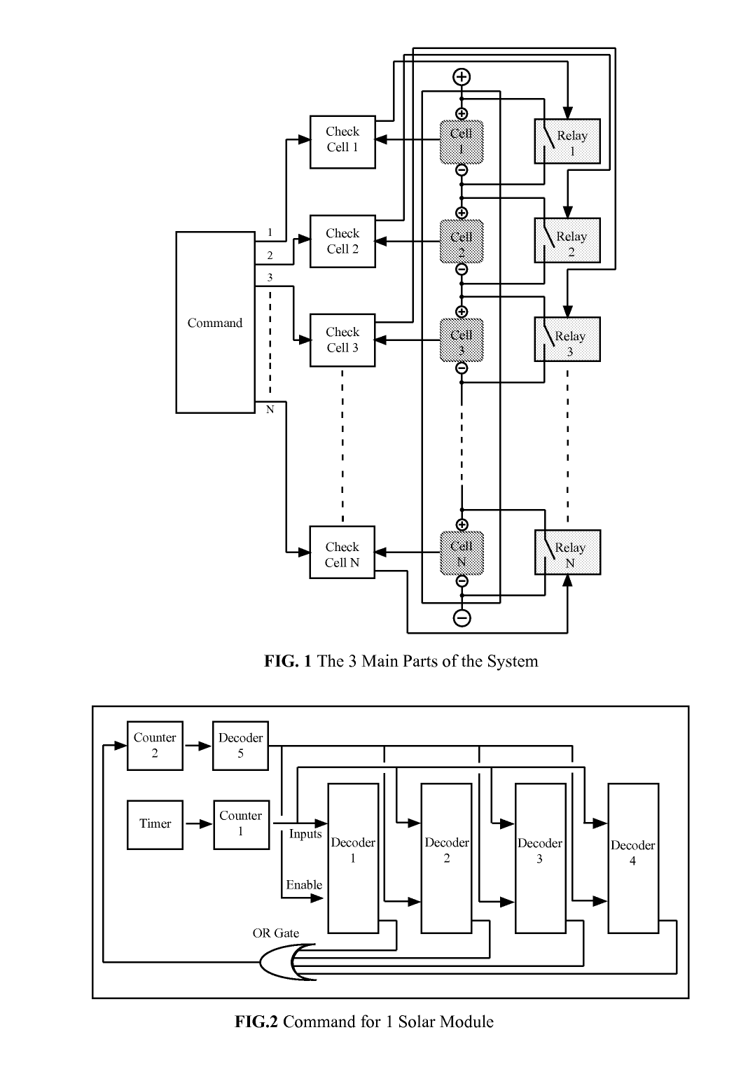

The present disclosure exposes the “method of cell isolation” in the solar module or solar array. The main objective is to prevent the shaded cell to affect the power of the module. The way to do that is to short-circuit the shaded cell using a power relay, open by default, that is in parallel with the cell. The shaded cell is then isolated within the module and replaced by a conducting wire which is the relay contacts. It is like having a new solar module without the shaded cell. Only the cells that are not shaded compose this new module. Around the solar module, the system is designed with 3 parts: the Command, the Check Cell, and the Relay (FIG. 1).

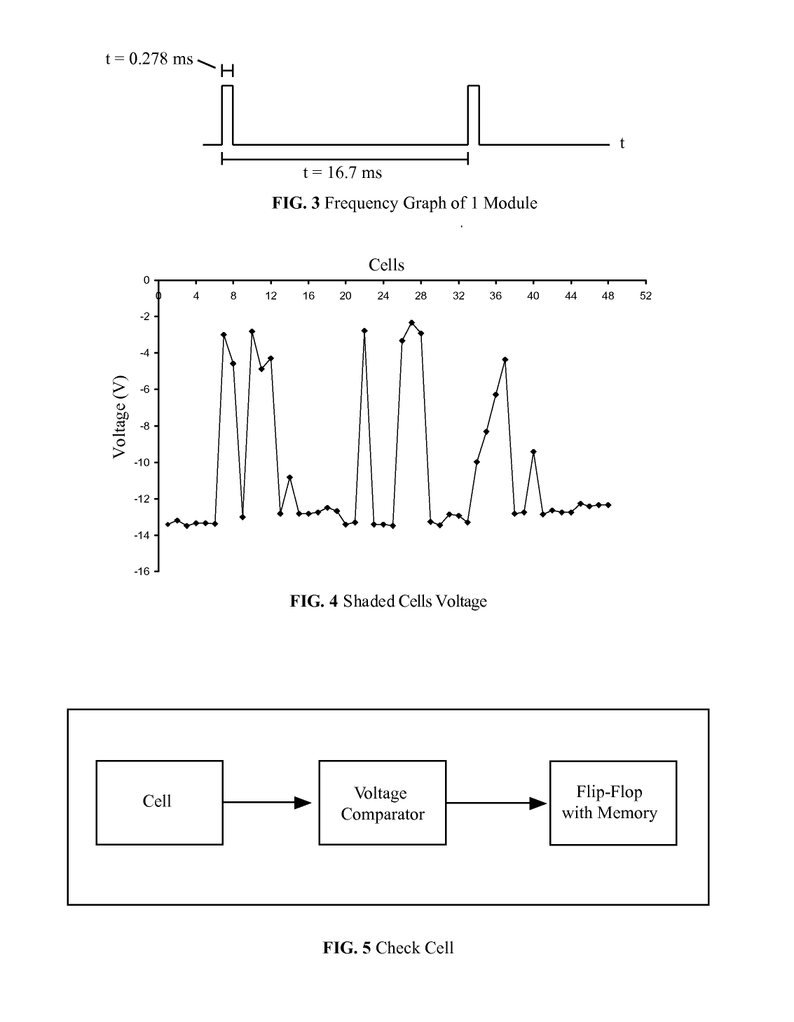

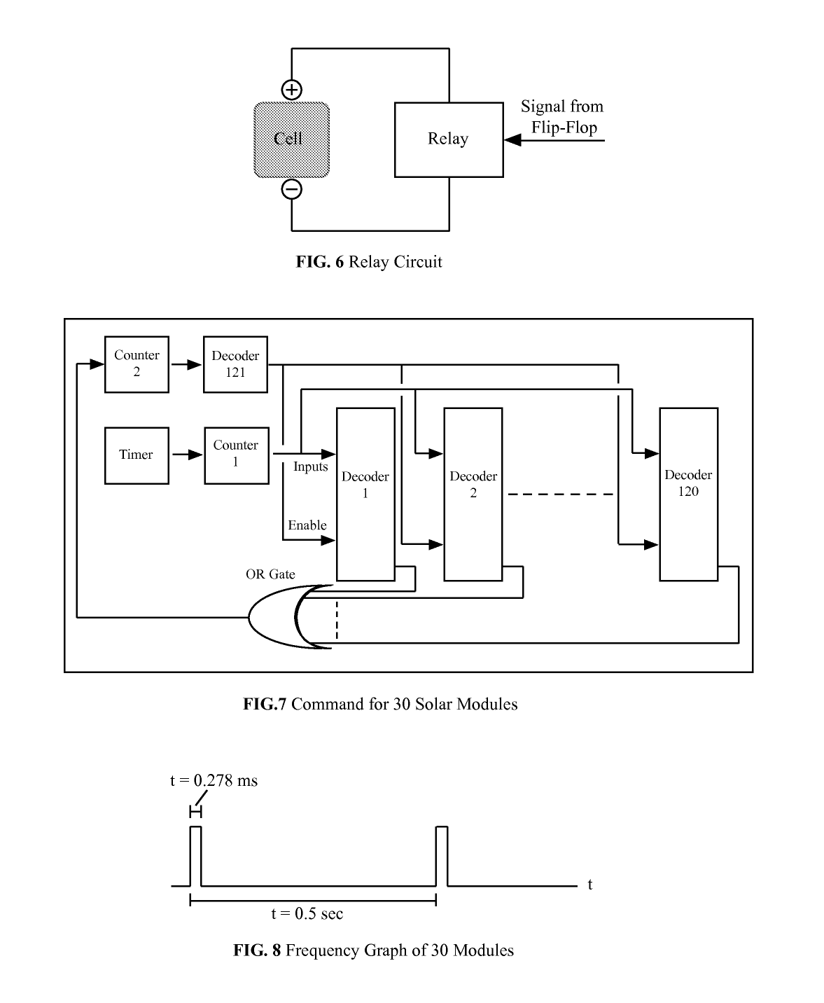

To give a general idea of how the Command circuit works, the Command is first designed for a standard solar module of 60 cells. The Command can be designed for any number of cells following the same principle. In this particular case, the Command has 60 outputs. Each output sends a pulse to one individual Check Cell. The pulse is sent in the loop from the first output to the last, and the loop repeats itself. Only one output is high at the time while the remaining outputs are all low. Within the Command, there are a Timer and 4 Decoders of 16 high outputs each (FIG. 2). These 4 Decoders give the 60 outputs of the Command. The reed relay PRMA 2-form-A is used in the Check Cell circuit, and its operating time is 25 ms which corresponds to 4000 Hz. With 10% margin of error, the frequency of the timer is set at 3600 Hz. With 60 outputs, each output of the Command sends its pulse 60 times per second. The advantage for one module in this case is that the device will react very fast to a shading situation. FIG. 3 shows the frequency graph of one output of this Command. The pulse lasts 0.278 ms. Consequently, the next output will send its pulse with a delay of 0.278 ms and so on. For the same output, it takes 16.7 ms for the next pulse to be sent. This means the loop lasts 16.7 ms and it takes at most 16.7 ms for the device to react to a shading situation.

One Check Cell circuit is in contact with one cell of the module to measure its voltage (FIG. 5). The Check Cell receives a pulse from one output of the Command. During the pulse time, the Voltage Comparator compares the voltage of the cell against the reference voltage connected to the ground (zero volt). If the voltage of the cell goes below zero volt, which means the cell is shaded enough to affect the power of the module, the Flip-Flop sends a signal to the Relay circuit and the power relay closes. The cell is short-circuited and isolated. The main current flows through the relay. At the same time, the Flip-Flop keeps this value in its memory. When the pulse ends, the next Check Cell repeats the same function for the next cell, and so on. In the mean time, the power relay of the previous cell stays closed until its Check Cell receives another pulse from the Command's output in the next loop. If the voltage is still negative, the value of the memory stays the same, and the power relay is still closed. But if the cell's voltage becomes positive, then the Flip-Flop's memory is cleared and the relay opens. Another advantage of this design is that if a cell within the module fails to provide it required power, because of the dissymmetry it presents compared to the other cells in the module, it voltage decreases very fast when the solar irradiance decreases as well. At some point, its voltage can cross the zero voltage boundary and become negative. As a result of failure, without being shaded, a failed cell's voltage can become negative within a solar module and affect the power of the module. When this happens, the device isolates this cell as well.

During the pulse time, the Check Cell compares the cell's voltage against the reference voltage. This means the negative polarity of the cell is also connected to the ground. Because all the cells are in series within the module, to prevent a conflict between the cells polarities reed relays are used in the Check Cell circuit to isolate the cells with the ground. So, during the pulse time, the reed relay connects the cell's negative polarity to the ground. Only this cell has its negative polarity connected to the ground at that pulse time while the remaining cells have their negative polarity disconnected from the ground. For the same reason, the Command circuit is designed such a way that only one pulse is sent a the time. Knowing the operating time of the reed relay with the margin of error, the frequency of the Timer in the Command circuit is determined. In the example of the reed relay PRMA 2-form-A, the operating time is 0.25 ms. This corresponds to a frequency of 4000 Hz. With 10% margin of error, the frequency of the Timer is set at 3600 Hz and each pulse lasts 0.278 ms. Since the pulse time does not change because it is determined by the frequency of the Timer, a device that has one solar module will react much faster to a shading situation than a device that has many solar modules. For instance, in a standard solar module, each cell is checked 60 times in one second which means the device has at most 16.7 ms to react. Whereas, in a array of 30 solar modules the cells are checked only 2 times per second which means the device has at most 0.5 sec to react. The device reacts 30 times faster in the first case. How this affects the performance of the device? Not much because it is not important how fast the shadow appears and disappears.

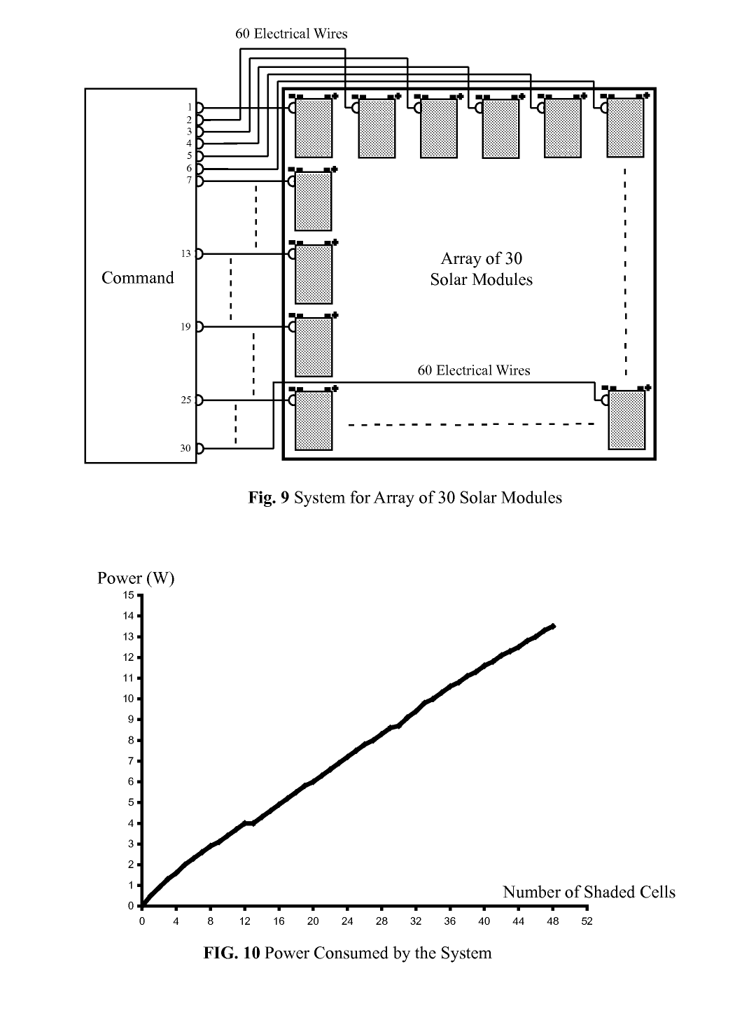

The Command can be designed for any number of cells. FIG. 9 is an example of a system designed for an array of 30 standard solar modules. The Command circuit which is designed to handle 1800 cells has 30 groups of 60 outputs each. Each group is connected to one solar module in the array. Another way to explain this is that the Command treats the entire array as one entity dealing with one cell at the time. A very interesting thing here is that the modules positive and negative electrical power outputs are left unused. Any device and apparatus can be used to harvest the power of the array. The present disclosure does not deal with how the power of the modules will be collected. It does not matter.

The system is powered by a symmetrical power supply, +5 V and −5 V. The relays (reed relay and power relay) are all 5 V relay. If 12 V power relay is chosen, then 12 V power supply may be used. The power consumed by the system is mostly due to the power relay. FIG. 10 is the graph of the power consumed by the device versus the number of shaded cells in 48 cells solar module. The graph is almost linear which means the power consumed by the device is proportional to the number of cells shaded. When there is no shading and the power relays are all open, the system consumes a vey low power (close to zero). This means almost no power is wasted when there is no shading situation. For instance, the specifications of the power relay SRD-05VDC-SL-C are 5 V direct current and 0.36 W power. Using this relay in the design, the positive power supply for one standard module is 21.6 W. The negative power supply is required only to detect the negative voltage of the shaded cell. It does not need much power which can be kept as low as possible. The experiment shows that for one module 0.1 watt is sufficient.

While some illustrative embodiments and methods of the present disclosure have been exposed herein, variations and modifications of such method can be made while keeping the spirit and the extent of the method. Many works have been done in the intent to save power in photovoltaic power array with respect to shading situations. Many examples exist and differ from others in matters of details only. For this reasons, it is intended that the art disclosed shall be limited only to the extent required by the appended claims and the rules and principles of applicable law.

I claim:

1. A method of providing a solar module device that isolates the shaded cell(s) within the module.

2. A method of providing a solar array device that isolates the shaded cell(s) within the array. The method comprises 3 parts:
a. the Command that send a pulse to the Check Cell;
b. the Check Cell that compares the cell's voltage with a reference voltage;
c. the power relay that isolates the cell within the solar module or solar array.

3. The method of claim 1 and 2, wherein the solar module or solar array contains many solar cells.

4. The method of claim 3, wherein the solar cells are connected in series.

5. The method of claim 3, wherein the solar cells are connected in parallel.

6. The method of claim 3, wherein the solar cells are connected in a combination of parallel-series.
